(19) United States
(12) Patent Application Publication
(10) Pub. No.: US 2011/0094362 A1
(43) Pub. Date: Apr. 28, 2011

(54) Caster concept guard

(76) Inventor: James A. Pecore, Wasilla, AK (US)

(21) Appl. No.: 12/584,119

(22) Filed: Oct. 23, 2009

(51) Int. Cl. B26D 7/22

(52) U.S. Cl. 83/478

(57) ABSTRACT

This invention is easily adaptable to the wood working shops and promotes safety for the operator.

### BACKGROUND AND SUMMARY OF THE INVENTION

I like to work on wood products. I had a stroke and have limited use of my right arm. I go to therapy twice a week and have gained maybe 20% of original use. I do most projects with my left hand. I read all the wood working magazines, etc. and could not find the safety items I needed. I experimented and came up with a design that works excellent for me.

My invention allows me to hold down the materials, regardless of width or thickness. The curved arms of the Guard lets me use a push stick safely. The adjustable spring hold the material down. The plastic knobs make the assembly move in or out, forward or back or put to the side to be out of the way. That way, the machine can be used for other wood working projects.

### BRIEF DESCRIPTION OF DRAWINGS

Cover sheet depicts the complete Castor Concept Guard mounted on a table saw fence showing it's reach to keep material safely on the table.

Drawings 1-10 show the individual components to assemble.

### DETAILED DESCRIPTION OF PREFERRED EMBODIMENT

This substitution contains no new matter.

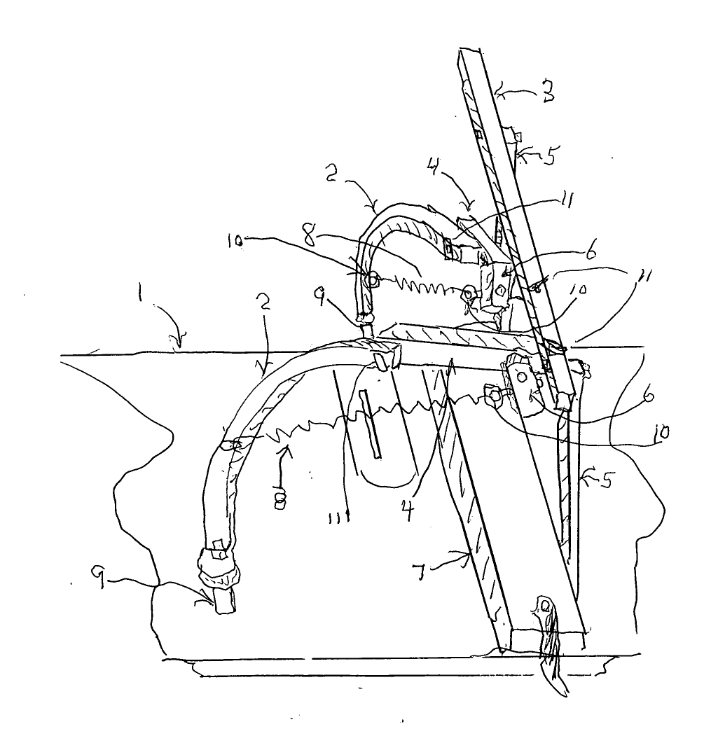

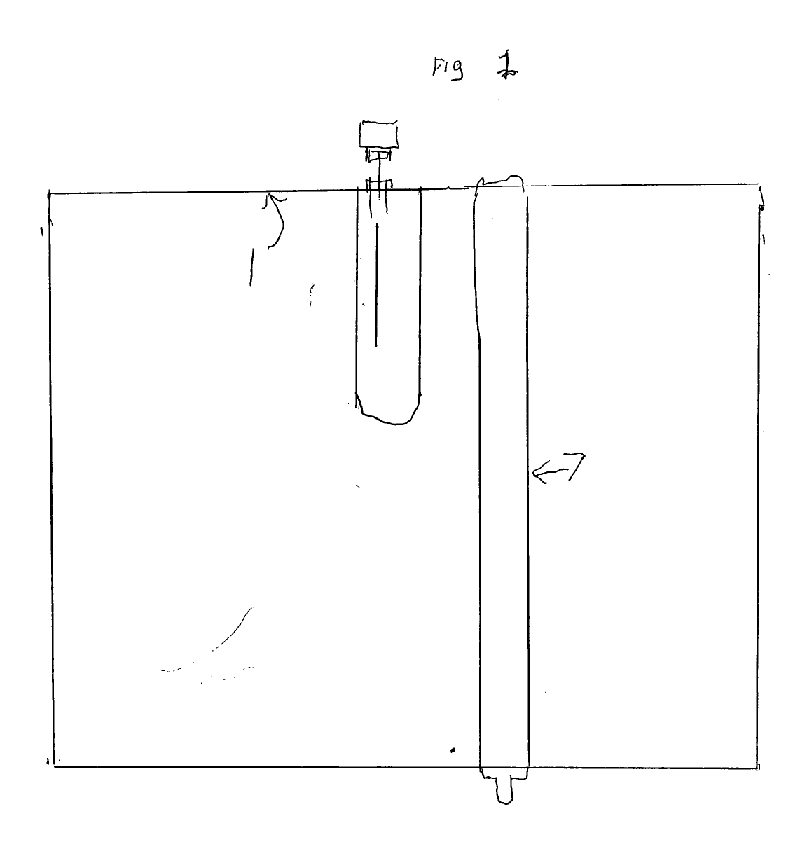

1. Referring to FIG. 1, the table saw top.

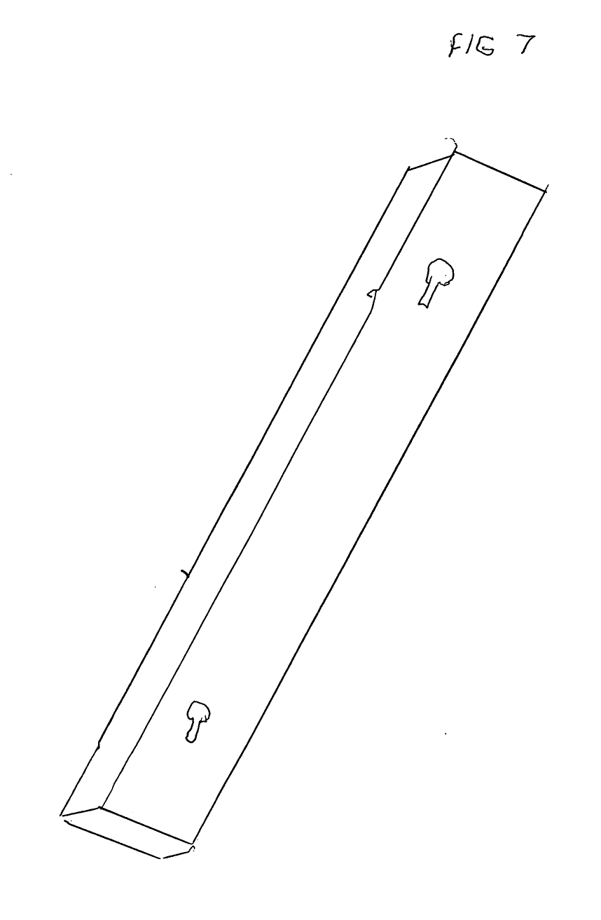

This is a 10 inch Sears Craftsman Table Saw. This also shows the saw fence, FIG. 7, which is the start for the uprights.

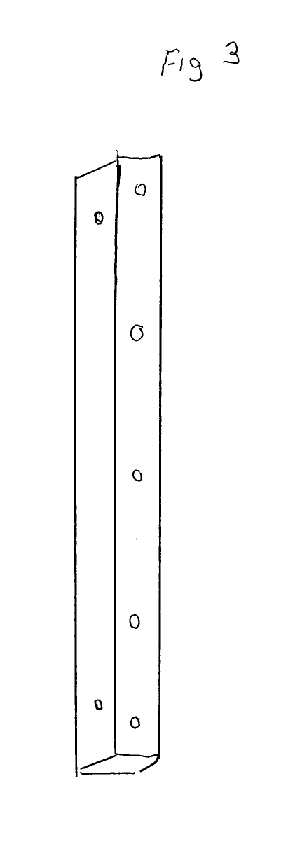

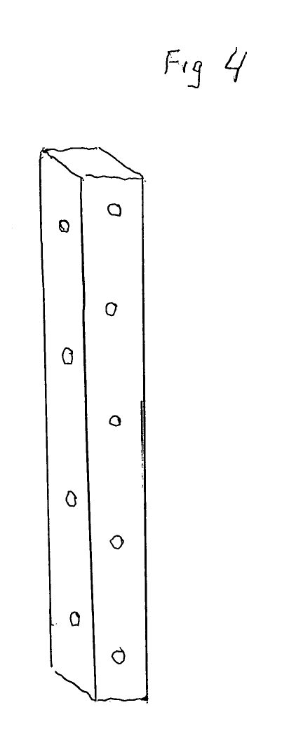

2. FIG. 7 shows the saw fence, made by Sears, with keyhole slots 18 inches apart. The upright consists of using 1 inch square metal stock, 10 inches long with holes drilled ½ inch from ends. I use 3/16×1½ round head bolts to mount the uprights to the 22 inch crossbar, FIG. 3. In two ¼ inch holes through the metal on the crossbar at 18 inches apart, you bolt to the uprights with ¼×1½ long bolt. The topside was predrilled with five ¼ inch holes spaced, starting at ½ inch from each end, again at 5 inches from each end and one in the center. To the end towards the operator, bolt one spacer at the ½ inch hole towards the saw blade, FIG. 4, with two Quick Release Plastic Knobs. Then bolt the right angle arm to the spacer with another Quick Release Plastic Knob.

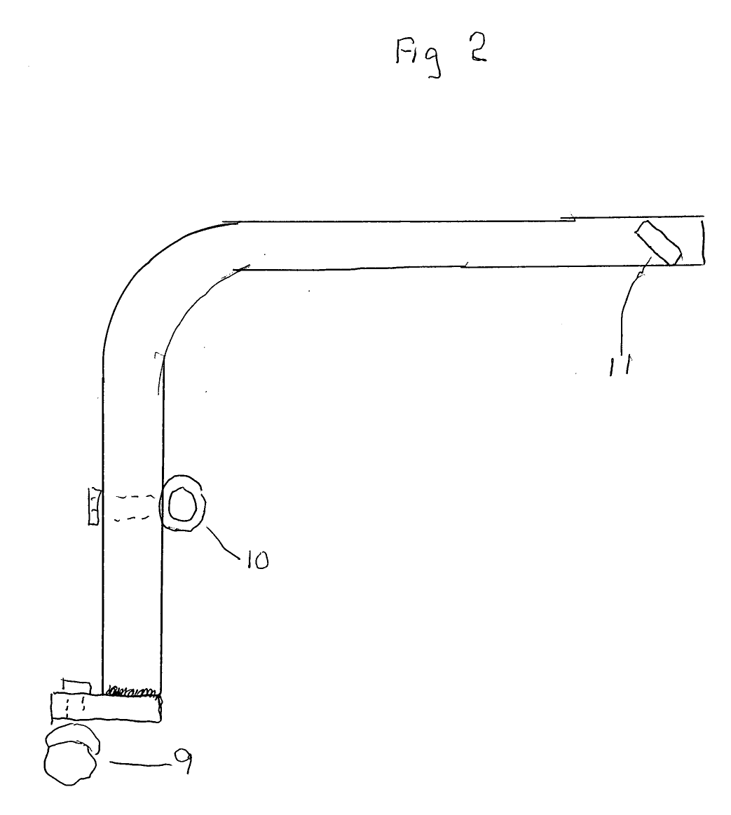

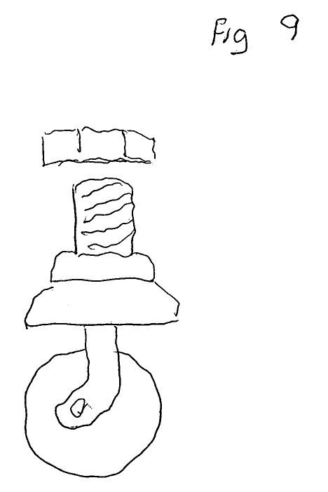

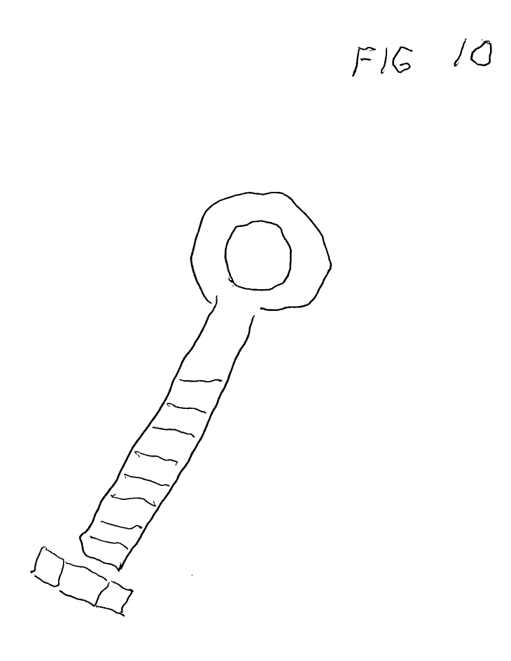

3. FIG. 2 shows one of two arms, showing the 90 degree bend, 8 inches across and 10 inches down to the metal plate mounted (welded) onto the 1 inch square steel tubing which is used for all the components. The metal plate is ¼×2×2 with a ⅜ inch hole drilled for a 2 inch in diameter swiveling caster FIG. 9. Also shown is a ¼dia×2 inch long eye bolt, FIG. 10.

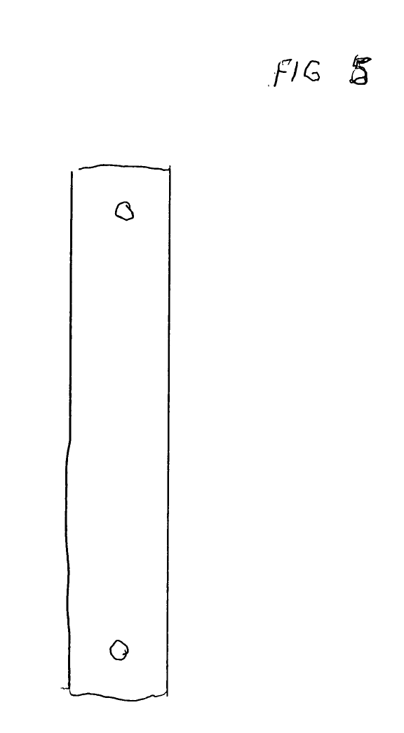

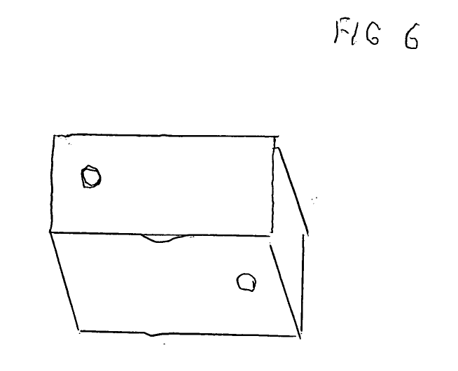

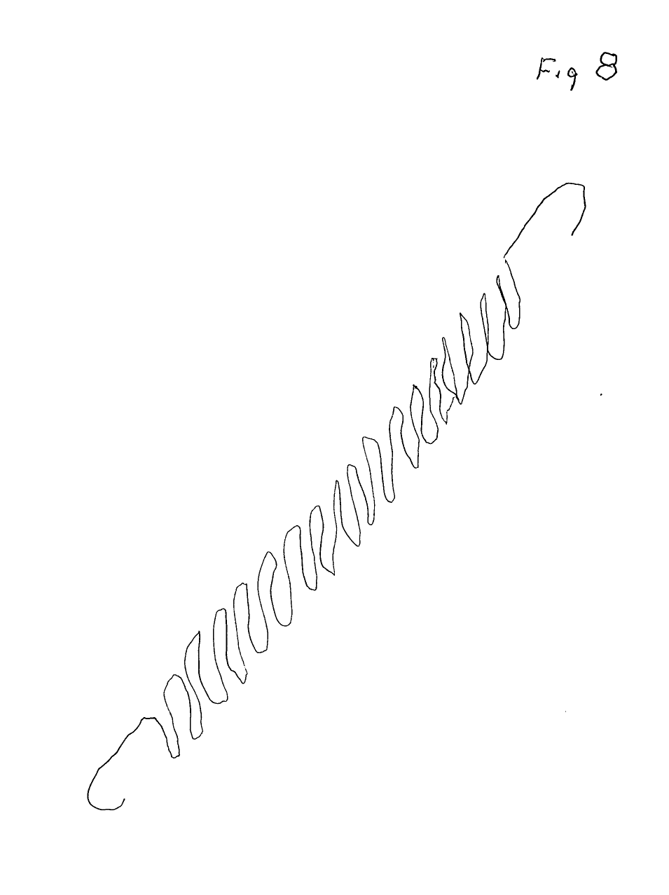

4. The spring eye bolt block, FIG. 6, then goes on the spacer side with the block being placed on the end toward the crossbar. Tilt this block down so the eye bolt and spring, FIG. 8, align with the eye bolt on the curved arm. This eye bolt has longer threads, 4-6 inches long, to tighten spring pressure as needed. The other spacer and curved arm goes to the middle hole on the crossbar, same configuration.

All the components are built with one inch square metal tubing, drilled with ¼ inch holes through the tubing and put together with 1½ inch bolts with flat ¼ inch washers as needed.

1. It was my idea for the bent arms for clearance.

2. Using the swiveling casters allows push stick clearance and lets the arms reach anywhere.

3. The arms reach from 1 inch out to 12 inches and could easily be extended.

4. My spring set up is adjustable for tension.

5. The guard is able to get out of the way easily without having to remove it.
